(19) United States
(12) Patent Application Publication
(10) Pub. No.: US 2022/0012220 A1
(43) Pub. Date: Jan. 13, 2022

(54) DATA ENLARGEMENT FOR BIG DATA ANALYTICS AND SYSTEM IDENTIFICATION

(71) Applicant: INTERNATIONAL BUSINESS MACHINES CORPORATION, ARMONK, NY (US)

(72) Inventors: Zhi Yong Jia, Xian (CN); Yu Ying YY Wang, Shannxi (CN); Wei Liu, Shaanxi (CN); Liu Yao He, Beijing (CN)

(21) Appl. No.: 16/946,790

(22) Filed: Jul. 7, 2020

(51) Int. Cl. G06F 16/22; G06K 9/62; G06N 3/02

(52) U.S. Cl. CPC G06F 16/2219; G06N 3/02; G06K 9/6215; G06K 9/6219

(57) ABSTRACT

The present invention may include a computer receives raw data. The computer converts the raw data into a dataset, where the dataset comprises independent variables and dependent variables. Then, the computer clusters the dataset to determine a corresponding target value to each of a plurality of clusters. The computer constructs a nonlinear programming problem based on a prior experience and generates an enlarged dataset by solving the nonlinear programming problem.

### BACKGROUND

The present invention relates, generally, to the field of computing, and more particularly to big data analytics.

Big data typically applies to data sets whose size or type is beyond the ability of traditional relational databases to capture, manage and process with low latency. Analysis of big data allows analysts, researchers and business users to make better and faster decisions using data that was previously inaccessible or unusable. Businesses can use advanced analytics techniques such as text analytics, machine learning, predictive analytics, data mining, statistics and natural language processing to gain new insights from previously untapped data sources independently or together with existing enterprise data.

### SUMMARY

According to one embodiment, a method, computer system, and computer program product for data enlargement is provided. The present invention may include a computer receives raw data. The computer converts the raw data into a dataset, where the dataset comprises independent variables and dependent variables. Then, the computer clusters the dataset to determine a corresponding target value to each of a plurality of clusters. The computer constructs a nonlinear programming problem based on a prior experience and generates an enlarged dataset by solving the nonlinear programming problem.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational flowchart illustrating a data enlargement process according to at least one embodiment;

FIG. 3 is a visualization of a typical dataset arrangement, according to at least one embodiment;

FIG. 4 is a visualization of hierarchical clustering of data from the dataset, according to at least one embodiment;

FIG. 5 is a block diagram of internal and external components of computers and servers depicted in FIG. 1 according to at least one embodiment;

FIG. 6 depicts a cloud computing environment according to an embodiment of the present invention; and

FIG. 7 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to big data analytics. The following described exemplary embodiments provide a system, method, and program product to, among other things, enlarge limited data to allow the big data advanced analysis especially for neural network based systems such as machine learning and deep learning algorithms, when the raw data is small and cannot be used for big data analytics. Therefore, the present embodiment has the capacity to improve the technical field of big data analytics by enlarging small data sets using construction of a nonlinear programming problem that is based on data clustering according to prior business experience and then, enlarging the small data set by solving the nonlinear programming problem.

As previously described, big data typically applies to data sets whose size or type is beyond the ability of traditional relational databases to capture, manage and process with low latency. Analysis of big data allows analysts, researchers and business users to make better and faster decisions using data that was previously inaccessible or unusable. Businesses can use advanced analytics techniques such as text analytics, machine learning, predictive analytics, data mining, statistics and natural language processing to gain new insights from previously untapped data sources independently or together with existing enterprise data.

Typically, advanced data analytics especially machine learning and deep learning techniques require, as a precondition, sufficient and ample amounts of data. Data enlargement is the most effective approach in order to allow big data analytics for small datasets, such as resampling based on data distribution. However, this approach of data enlargement does not consider prior experience and specifics of the enterprise. As such, it may be advantageous to, among other things, implement a system that aligns the existing raw data into a dataset, clustering the dataset based on the multiple independent variables and using the target values from the clustering, solving a nonlinear programming problem that is based on the prior experience of the enterprise and thus enlarging the existing data with the solutions to the nonlinear programming problem.

The enlarged dataset may then be used for advanced applications and analytics of different fields, such as in equipment inspection, degradation processes, or corrosion research by using machine and/or deep learning data analytics. Furthermore, the proposed solution provides a method for converting a business problem into a mathematical problem that may be applied for data enlargement of a small dataset.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to enlarge an existing dataset using nonlinear programming problem solutions as an additional values for the dataset.

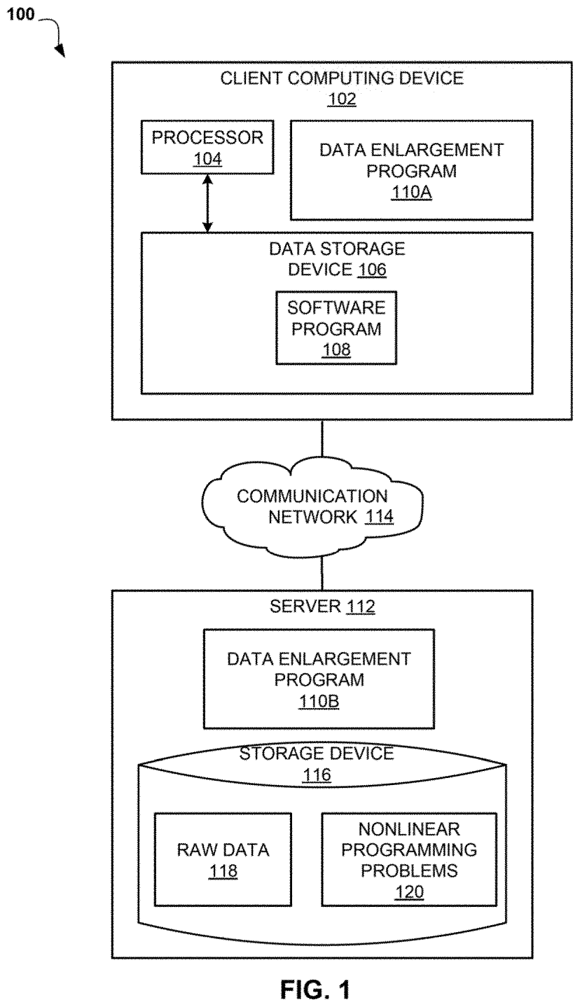

Referring to FIG. 1, an exemplary networked computer environment 100 is depicted, according to at least one embodiment. The networked computer environment 100 may include client computing device 102 and a server 112 interconnected via a communication network 114. According to at least one implementation, the networked computer environment 100 may include a plurality of client computing devices 102 and servers 112, of which only one of each is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

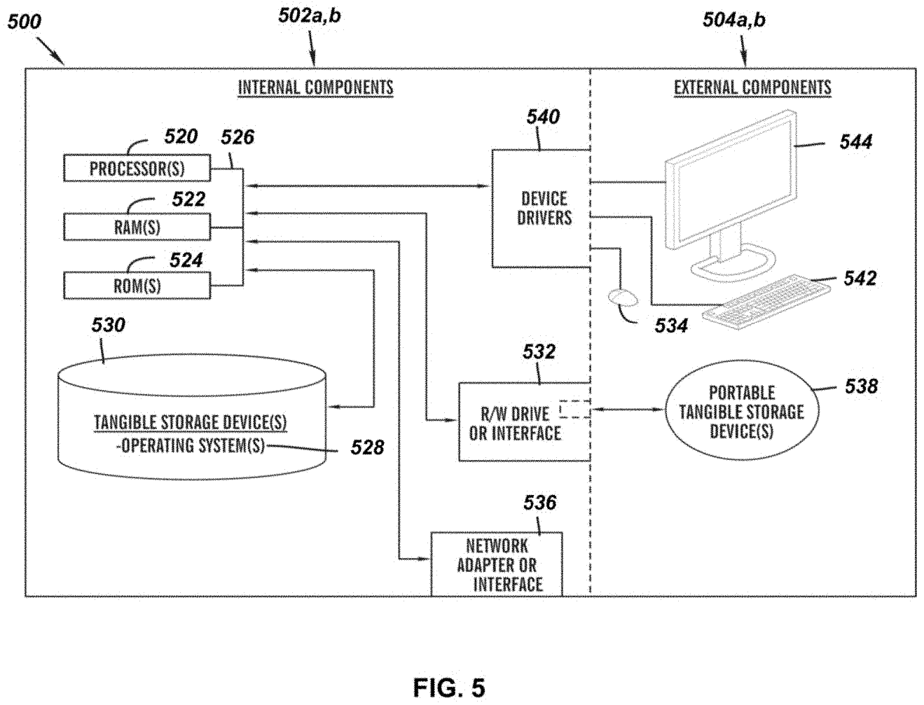

Client computing device 102 may include a processor 104 and a data storage device 106 that is enabled to host and run a software program 108 and a data enlargement program 110A and communicate with the server 112 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 5, the client computing device 102 may include internal components 502a and external components 504a, respectively.

The server computer 112 may be a laptop computer, netbook computer, personal computer (PC), a desktop computer, or any programmable electronic device or any network of programmable electronic devices capable of hosting and running a data enlargement program 110B and a storage device 116 and communicating with the client computing device 102 via the communication network 114, in accordance with embodiments of the invention. As will be discussed with reference to FIG. 5, the server computer 112 may include internal components 502b and external components 504b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

The storage device 116 may store raw data 118 and nonlinear programming problems 120. Raw data 118 may be a database that stores values in an organized or unorganized format and used by the data enlargement program 110A, 110B. The nonlinear programming problems may be a set of equations that may be used by the data enlargement program 110A, 110B or a computing code that represents the equations and may be incorporated by the data enlargement program 110A, 110B for calculations.

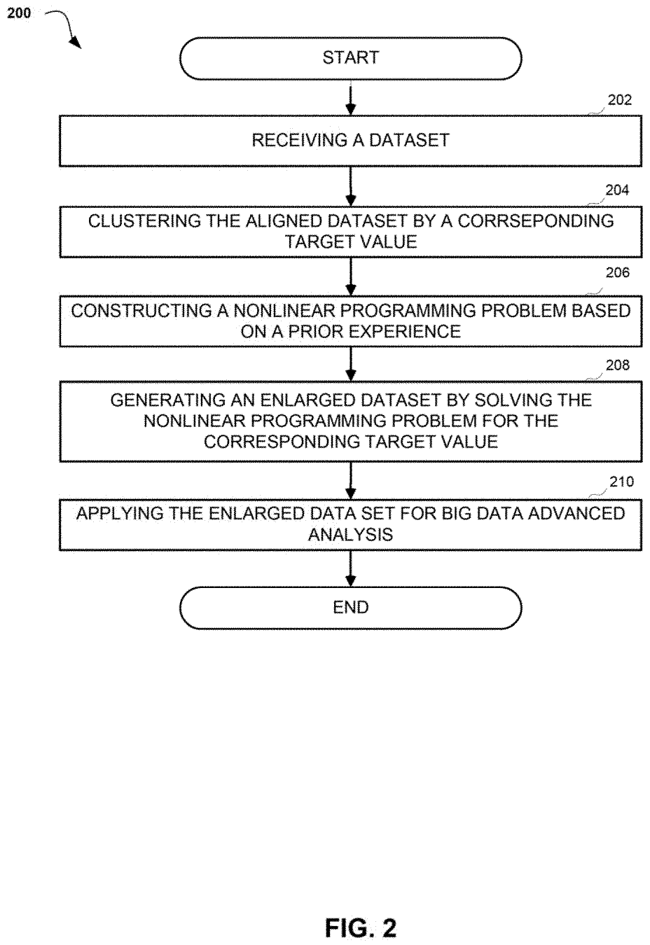

According to the present embodiment, the data enlargement program 110A, 110B may be a program capable of data enlargement of a short dataset by clustering the independent values of the dataset and using the values for solving a nonlinear problem in order to generate additional values that are used to enlarge the dataset. The data enlargement method is explained in further detail below with respect to FIG. 2.

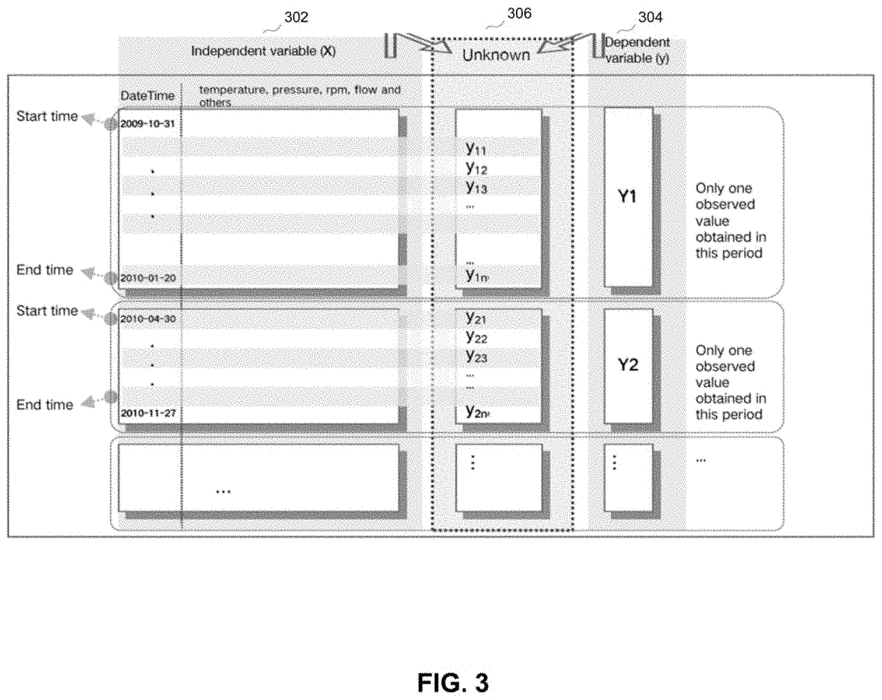

Referring now to FIG. 2, an operational flowchart illustrating a data enlargement process 200 is depicted according to at least one embodiment. At 202, the data enlargement program 110A, 110B receives a dataset. According to an example embodiment, the dataset may be extracted from all of or a subset of raw data that is stored in the raw data 118. The dataset may be in an organized and aligned format, such as structured as a table visualized in FIG. 3, having independent variables (X) 302, dependent variables (Y) 304 and unknown variables 306 columns that may be derived from dependent and independent variables using nonlinear problem solving.

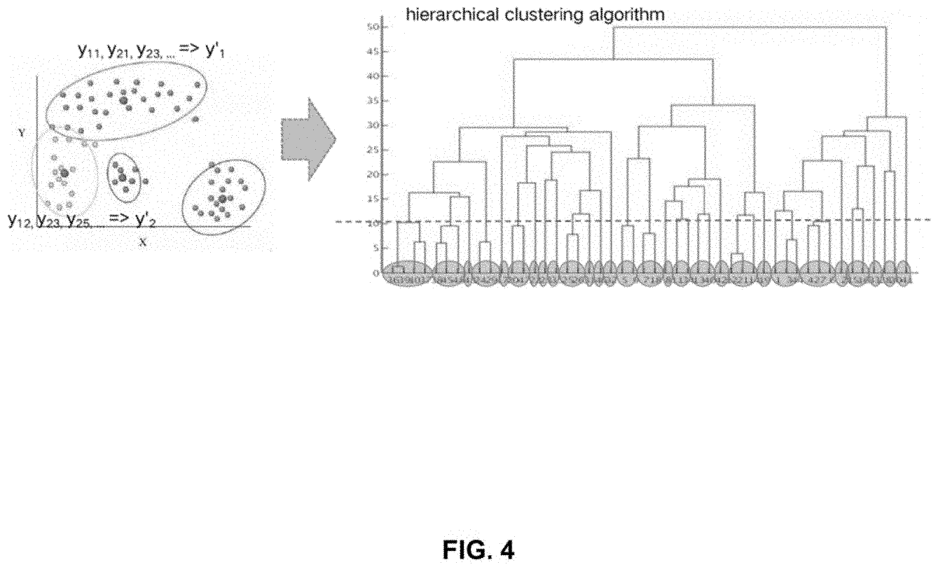

Next, at 204, the data enlargement program 110A, 110B clusters the aligned dataset by a corresponding target value. According to an example embodiment, the data enlargement program 110A, 110B performs a hierarchical clustering of the aligned raw data while assuming the dependent variables change only due to independent variables. The hierarchical clustering may be determined based on a distance matrix generated in the background. As depicted in FIG. 4, the data enlargement program 110A, 110B reduces the number of unknown values (y) to simplify computing of nonlinear equations by clustering the dependent variables into a corresponding target value (y′).

Then, at 206, the data enlargement program 110A, 110B constructs a nonlinear programming problem based on a prior experience. According to an example embodiment, the data enlargement program 110A, 110B may generate nonlinear programming construction based on an existing set of nonlinear equations stored at the nonlinear programming problems 120 or may be entered by a user. Prior experience may be related to the field of the data and known nonlinear mathematical relations between the dependent and independent variables. For example, corrosion analysis nonlinear programming problem is described below.

Assuming Y and y are corrosion rates the nonlinear programming problem may be constructed using the differential equation:

$$\frac{{df 𝓎}_{i} dt}{dt} = {Y}_{i}$$

This equation may be rewritten as:

$$\frac{{\sum }_{k} {𝓎}_{i , k} \cdot {Δ t}_{i , k}}{{\sum }_{k} {Δ t}_{i , k}} = {Y}_{i} ,$$

where after clustering, several yᵢⱼ may be condensed into a single parameter y′ₖ, such as:

set( [symbol] ₁′, [symbol] ₂′ . . . , [symbol] ₙ′)<<=>>[[ [symbol] _{1,1}, [symbol] _{1,2}, . . . , [symbol] _{1,n1}],[ [symbol] _{2,1}, [symbol] _{2,2}, . . . , [symbol] _{2,n2}], . . . ,[ [symbol] _{m,1}, [symbol] _{m,2}, . . . , [symbol] _{m,nm}]].

Thus, the original proposition may be transformed into a nonlinear programming problem:

$$min f = \sum \vert {Y}_{i} - \frac{{\sum }_{k} {𝓎}_{i , k} \cdot {Δ t}_{k}}{{\sum }_{k} {Δ t}_{k}} ) \vert$$

$$s . t . \\ \begin{matrix}{𝓎}_{1}^{′} > 0 \\ {𝓎}_{2}^{′} >= 0 \\ … \\ {𝓎}_{2}^{′} >= 0\end{matrix}$$

By solving this problem pairs of Y and y may be determined and used to enlarge the dataset. In other scenarios, the corresponding nonlinear problem to prior experience in the field may be transformed into a simplified mathematical expression that then may be solved to enlarge the dataset.

Then, at 208, the data enlargement program 110A, 110B generates an enlarged dataset by solving the nonlinear programming problem for the corresponding target value. According to an example embodiment, the data enlargement program 110A, 110B may generate pairs of X and y by combining any two sets from an existing dataset, where y′_{new} and X′_{new} is a new set that may be added to the dataset:

$${𝓎}_{new}^{′} = \frac{{𝓎}_{i} \cdot {Δ t}_{i} + {𝓎}_{j} \cdot {Δ t}_{j}}{{Δ t}_{i} + {Δ t}_{j}}$$

$${X}_{new}^{′} = [ {X}_{i} , {X}_{j} ]$$

In further embodiments, data enlargement program 110A, 110B may automatically determine a corresponding nonlinear problem from the nonlinear programming problems 120 database. The corresponding nonlinear problem may be determined based on the parameters of the dataset that requires enlargement, such as by matching variable names, types or names of data fields in the dataset. In another embodiments, the corresponding nonlinear problem may be determined based on previous requests of a user while using the program.

Next, at 210, the data enlargement program 110A, 110B applies the enlarged dataset for a big data advanced analysis. According to an example embodiment, the data enlargement program 110A, 110B may use the enlarged dataset as an input for machine learning and/or deep learning algorithms.

It may be appreciated that FIG. 2 provides only an illustration of one implementation and does not imply any limitations with regard to how different embodiments may be implemented. Many modifications to the depicted environments may be made based on design and implementation requirements. In an alternate embodiment, the method may be used for an industrial equipment inspection, especially where there is a small sample dataset that needs to be enlarged.

FIG. 3 is a visualization of a typical dataset arrangement, according to at least one embodiment. A typical dataset may have data that may be arranged as a table having independent variables (X) 302, dependent variables (y) 304 such as Y1, Y2, . . . , that are obtained in a coarse-grained way during sampling period. However, in order to use data analytics, more fine grained values are required, such as y₁₁, y₁₂, . . . y₂ₙ, that are depicted as an unknown table 306.

FIG. 4 is a visualization of hierarchical clustering of data from the dataset, according to at least one embodiment. According to an example embodiment, a hierarchical algorithm is applied to the raw data in order to reduce the number of unknown variables and thus, simplify the computations during the solution step. The determined target value (y′₁) is used in order to increase the dataset in the solution step (see FIG. 2, step 208).

FIG. 5 is a block diagram 500 of internal and external components of the client computing device 102 and the server 112 depicted in FIG. 1 in accordance with an embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

The data processing system 502, 504 is representative of any electronic device capable of executing machine-readable program instructions. The data processing system 502, 504 may be representative of a smart phone, a computer system, PDA, or other electronic devices. Examples of computing systems, environments, and/or configurations that may represented by the data processing system 502, 504 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The client computing device 102 and the server 112 may include respective sets of internal components 502 a,b and external components 504 a,b illustrated in FIG. 5. Each of the sets of internal components 502 include one or more processors 520, one or more computer-readable RAMs 522, and one or more computer-readable ROMs 524 on one or more buses 526, and one or more operating systems 328 and one or more computer-readable tangible storage devices 530. The one or more operating systems 528, the software program 108 and the data enlargement program 110A in the client computing device 102, and the data enlargement program 110B in the server 112 are stored on one or more of the respective computer-readable tangible storage devices 530 for execution by one or more of the respective processors 520 via one or more of the respective RAMs 522 (which typically include cache memory). In the embodiment illustrated in FIG. 3, each of the computer-readable tangible storage devices 530 is a magnetic disk storage device of an internal hard drive. Alternatively, each of the computer-readable tangible storage devices 530 is a semiconductor storage device such as ROM 524, EPROM, flash memory or any other computer-readable tangible storage device that can store a computer program and digital information.

Each set of internal components 502 a,b also includes a R/W drive or interface 532 to read from and write to one or more portable computer-readable tangible storage devices 538 such as a CD-ROM, DVD, memory stick, magnetic tape, magnetic disk, optical disk or semiconductor storage device. A software program, such as the cognitive screen protection program 110A, 110B, can be stored on one or more of the respective portable computer-readable tangible storage devices 538, read via the respective R/W drive or interface 532, and loaded into the respective hard drive 530.

Each set of internal components 502 a,b also includes network adapters or interfaces 536 such as a TCP/IP adapter cards, wireless Wi-Fi interface cards, or 3G or 4G wireless interface cards or other wired or wireless communication links. The software program 108 and the data enlargement program 110A in the client computing device 102 and the data enlargement program 110B in the server 112 can be downloaded to the client computing device 102 and the server 112 from an external computer via a network (for example, the Internet, a local area network or other, wide area network) and respective network adapters or interfaces 536. From the network adapters or interfaces 536, the software program 108 and the data enlargement program 110A in the client computing device 102 and the data enlargement program 110B in the server 112 are loaded into the respective hard drive 530. The network may comprise copper wires, optical fibers, wireless transmission, routers, firewalls, switches, gateway computers and/or edge servers.

Each of the sets of external components 504 a,b can include a computer display monitor 544, a keyboard 542, and a computer mouse 534. External components 504 a,b can also include touch screens, virtual keyboards, touch pads, pointing devices, and other human interface devices. Each of the sets of internal components 502 a,b also includes device drivers 540 to interface to computer display monitor 544, keyboard 542, and computer mouse 534. The device drivers 540, R/W drive or interface 532, and network adapter or interface 536 comprise hardware and software (stored in storage device 530 and/or ROM 524).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

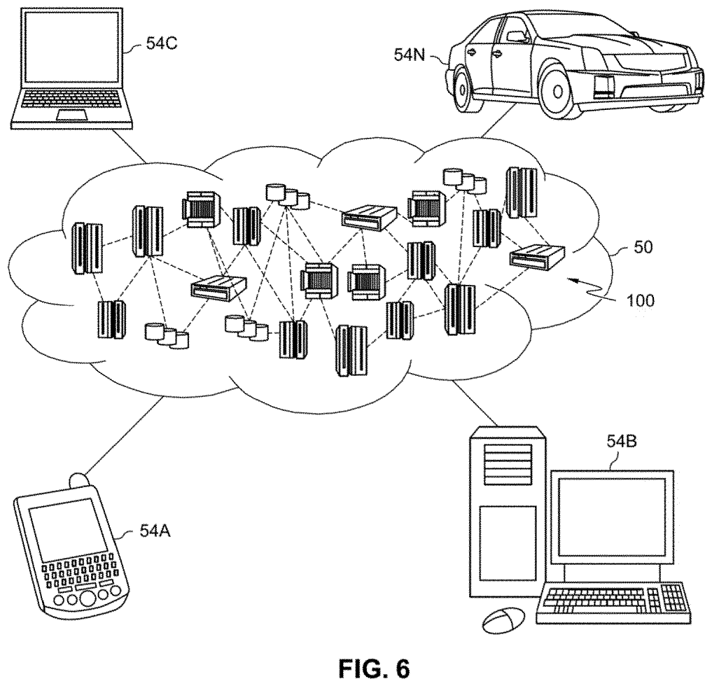

Referring now to FIG. 6, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 6 are intended to be illustrative only and that computing nodes 100 and cloud computing environment 50 can communicate with any type of computerized device over any type of network and/or network addressable connection (e.g., using a web browser).

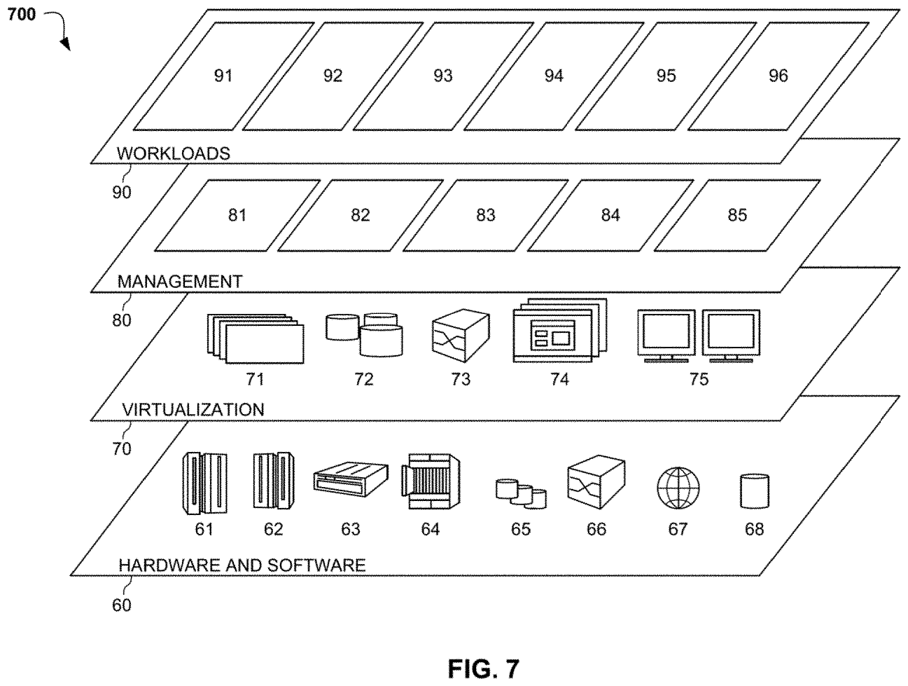

Referring now to FIG. 7, a set of functional abstraction layers 500 provided by cloud computing environment 50 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and dataset enlargement 96. Dataset enlargement 96 may relate to aligning and clustering the dataset and using the target values from the clustering to solve a nonlinear programming problem that is based on the business experience to enlarging the dataset with the solutions to the nonlinear programming problem in order to use the enlarged dataset with the machine learning techniques.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for data enlargement, the method comprising:
receiving raw data;
converting the raw data into a dataset, wherein the dataset comprises independent variables and dependent variables;
clustering the dataset to determine a corresponding target value to each of a plurality of clusters;
constructing a nonlinear programming problem from the independent variables and the corresponding target value to each of the plurality of clusters based on a prior experience; and
generating an enlarged dataset by solving the nonlinear programming problem.

2. The method of claim 1, further comprising:
applying the enlarged dataset for a big data advanced analysis, wherein the big data advanced analysis uses a neural network algorithm requiring the enlarged dataset.

3. The method of claim 1, wherein constructing a nonlinear programming problem further comprises:
determining, automatically, a corresponding nonlinear programming problem to the dataset from the nonlinear programming problems database based on parameters of the dataset.

4. The method of claim 1, wherein clustering the dataset to determine the corresponding target value to each of the plurality of clusters uses a hierarchical clustering that is based on a background-generated distance matrix.

5. The method of claim 1, wherein the prior experience is based on nonlinear mathematical relations between the dependent variables and the independent variables of the dataset.

6. The method of claim 1, wherein the nonlinear programming problem based on the prior experience is a corrosion rate, nonlinear programming problem.

7. The method of claim 1, wherein generating the enlarged dataset by solving the nonlinear programming problem further comprises using the corresponding target value as an input to the nonlinear programming problem.

8. A computer system for data enlargement, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
receiving raw data;
converting the raw data into a dataset, wherein the dataset comprises independent variables and dependent variables;
clustering the dataset to determine a corresponding target value to each of a plurality of clusters;
constructing a nonlinear programming problem from the independent variables and the corresponding target value to each of the plurality of clusters based on a prior experience; and
generating an enlarged dataset by solving the nonlinear programming problem.

9. The computer system of claim 8, further comprising applying the enlarged dataset for a big data advanced analysis, wherein the big data advanced analysis uses a deep neural network algorithm requiring the enlarged dataset.

10. The computer system of claim 8, wherein constructing a nonlinear programming problem further comprises determining, automatically, a corresponding nonlinear programming problem to the dataset from the nonlinear programming problems database based on parameters of the dataset.

11. The computer system of claim 8, wherein clustering the dataset to determine the corresponding target value to each of the plurality of clusters uses a hierarchical clustering that is based on a background-generated distance matrix.

12. The computer system of claim 8, wherein the prior experience is based on nonlinear mathematical relations between the dependent variables and the independent variables of the dataset.

13. The computer system of claim 8, wherein the nonlinear programming problem based on the prior experience is a corrosion rate, nonlinear programming problem.

14. The computer system of claim 8, wherein generating the enlarged dataset by solving the nonlinear programming problem further comprises using the corresponding target value as an input to the nonlinear programming problem.

15. A computer program product for data enlargement, the computer program product comprising:
one or more computer-readable tangible storage medium and program instructions stored on at least one of the one or more tangible storage medium, the program instructions executable by a processor, the program instructions comprising:
program instructions to receive raw data;
program instructions to convert the raw data into a dataset, wherein the dataset comprises independent variables and dependent variables;
program instructions to cluster the dataset to determine a corresponding target value to each of a plurality of clusters;
program instructions to construct a nonlinear programming problem from the independent variables and the corresponding target value to each of the plurality of clusters based on a prior experience; and
program instructions to generate an enlarged dataset by solving the nonlinear programming problem.

16. The computer program product of claim 15, further comprising applying the enlarged dataset for a big data advanced analysis, wherein the big data advanced analysis uses a deep neural network algorithm requiring the enlarged dataset.

17. The computer program product of claim 15, wherein program instructions to construct the nonlinear programming problem further comprises program instructions to determine, automatically, a corresponding nonlinear programming problem to the dataset from the nonlinear programming problems database based on parameters of the dataset.

18. The computer program product of claim 15, wherein clustering the dataset to determine the corresponding target value to each of the plurality of clusters uses a hierarchical clustering that is based on a background-generated distance matrix.

19. The computer program product of claim 15, wherein the prior experience is based on nonlinear mathematical relations between the dependent variables and the independent variables of the dataset.

20. The computer program product of claim 15, wherein the nonlinear programming problem based on the prior experience is a corrosion rate, nonlinear programming problem.
